(19) United States
(12) Patent Application Publication
(10) Pub. No.: US 2006/0050326 A1
(43) Pub. Date: Mar. 9, 2006

(54) Image processing apparatus, image processing method and image processing program

(75) Inventors: Yoshiharu Hirano, Mishima-shi (JP); Hidenobu Suzuki, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tech Kabushiki Kaisha, Chiyoda-ku (JP)

(21) Appl. No.: 10/934,716

(22) Filed: Sep. 3, 2004

(51) Int. Cl. H04N 1/00

(52) U.S. Cl. 358/448; 358/402

(57) ABSTRACT

An image processing apparatus is provided which is capable of efficiently performing image processing by separating a scan operation and subsequent processing operations in the image processing apparatus from each other. In the image processing apparatus 100 of the present invention, when an instruction to scan a multitude of sheets of a document is given, a CPU 10 for carrying out overall control makes the document read out by a scanning part 16, stores the scanned data thus read out in a HDD 13, and temporally terminates the operation in the absence of an instruction for subsequent processing. Thereafter, when an instruction to perform printing (copying), for instance, of scanned data stored in the HDD 13 is received from a user through an input and output part 14, a printing part 19 corresponding the received instruction among a plurality of subsequent processing functions is operated so that a task of copying the document is completed. Accordingly, other rush operations can be interrupted between the scan operation and the print operation so as to carry out image processing efficiently.

### BACKGROUND OF THE INVENTION

1. Field of the Invention

The present invention relates to an image processing apparatus, and in particular, to an image processing method and an image processing apparatus capable of exerting a variety of kinds of functions such as copy printing, fax transmission, email transmission, etc., based on image data read by a scanner.

2. Description of the Related Art

In recent years, image processing apparatuses (Image forming apparatuses), as being called multi-function printers (Multi-Function Printers), have not only a copy function, but also a scan function, a print function, a fax function, an email function and so on available to users, and hence are becoming complicated in their functions. Because of being multi-functioned in such a manner, a single same image processing apparatus is required to do various processing tasks in a quick and efficient manner.

However, when the copy function is used in the above-mentioned conventional image processing apparatuses, operations from the scanning of a document up to the completion of printing thereof become a series of operations. Therefore, if a large number of copies, for example, hundreds of sheets of copies are to be made, the image processing apparatus in use can not be supplied to the use of other persons or to the use of other functions for a period of time from the start of scanning until the completion of a process of printing the large number of sheets. Accordingly, there arises a problem that even for such a processing task as can be done by the image processing apparatus in a short time, it is necessary, in some cases, for the user to wait for a long time until the processing task can be started. With respect to functions other than the copy function, there will be a similar problem from the view point of resulting in a series of operations.

### SUMMARY OF THE INVENTION

The present invention is intended to obviate the problems as referred to above, and has for its object to provide an image processing apparatus, an image processing method, and an image processing program which are capable of permitting a subsequent processing task to be performed at appropriately selected timing without bringing a scan operation and subsequent processing operations in the image processing apparatus together into a series of operations, reducing a long time spent waiting for other use requests, and enabling image processing to be performed in an efficient manner.

In order to solve the above-mentioned problems, the present invention resides in an image processing apparatus comprising: a scan function part that acquires image data by reading a document: an image data storage part that stores the image data acquired by the scan function part an input part by which an instruction for subsequent processing with respect to the processing performed by the scan function part; and a subsequent processing function part that performs the subsequent processing based on the instruction for subsequent processing input by the input part by using the image data stored in the image data storage part.

Here, the subsequent processing function part has a function to perform a plurality of kinds of subsequent processing operations that can be selected by the input part. In addition, subsequent processing functions that can be executed by the subsequent processing function part include at least a print function and a fax transmission function.

Moreover, the present invention resides in an image processing apparatus comprising: a scan function part that acquires Image data by reading a document; an image data storage part that can store the image data acquired by the scan function part, a subsequent processing function part that can perform subsequent processing with respect to the scan processing of the scan function part: an input part by which an instruction for the subsequent processing performed by the subsequent processing function part; a control part that stores the image data read by the scan function part in the image data storage part, temporally terminates the processing operation, and actuates, upon receipt of the instruction for subsequent processing through the input part, the subsequent processing function part thereby to perform the subsequent processing on the image data stored in the image data storage part.

Further, the present invention resides in an image processing method comprising: a scan step of acquiring image data by reading a document; an image data storage step of storing the image data acquired in the scan step; an input step of inputting an instruction for subsequent processing with respect to the processing performed in the scan step; and a subsequent processing step of performing the subsequent processing based on the instruction for subsequent processing input in the input step by using the image data stored in the image data storage step.

Furthermore, the present invention resides in an image processing method comprising: a scan step of acquiring image data by scanning a document; an image data storage step of storing the image data thus acquired: an operation termination step of temporally terminating the processing operation until an instruction for subsequent processing on the stored image data is given; and a subsequent processing step of performing, upon receipt of an instruction for subsequent processing on the image data, subsequent processing corresponding to the instruction by using the image data stored in the image data storage step.

Still further, the present invention resides in an image processing program adapted to be executed in a computer of an image processing apparatus, the program being operable to make the computer execute: a scan step of acquiring image data by reading a document; an image data storage step of storing the image data acquired in the scan step: an input step of inputting an instruction for subsequent processing with respect to the processing performed in the scan step; and a subsequent processing step of performing the subsequent processing based on the instruction for subsequent processing input in the input step by using the image data stored in the image data storage step.

In addition, the present invention resides in an image processing program adapted to be executed in a computer of an image processing apparatus, the program being operable to make the computer execute: a scan step of acquiring image data by scanning a document: an image data storage step of storing the image data thus acquired; an operation termination step of temporally terminating the processing operation until an instruction for subsequent processing on the stored image data is given; and a subsequent processing step of performing, upon receipt of an instruction for subsequent processing on the image data, subsequent processing corresponding to the instruction by using the image data stored in the image data storage step.

### BRIEF DESCRIPTION OF THE DRAWINGS

FIG. 1 is a block diagram showing a constructional example of one embodiment of an image processing apparatus of the present invention.

FIG. 2 is a flow chart explaining the control operation of a CPU shown in FIG. 1.

### DESCRIPTION OF THE PREFERRED EMBODIMENT

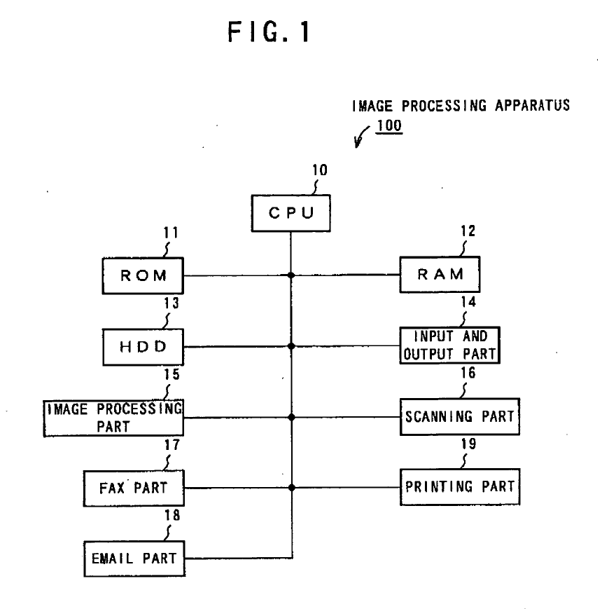

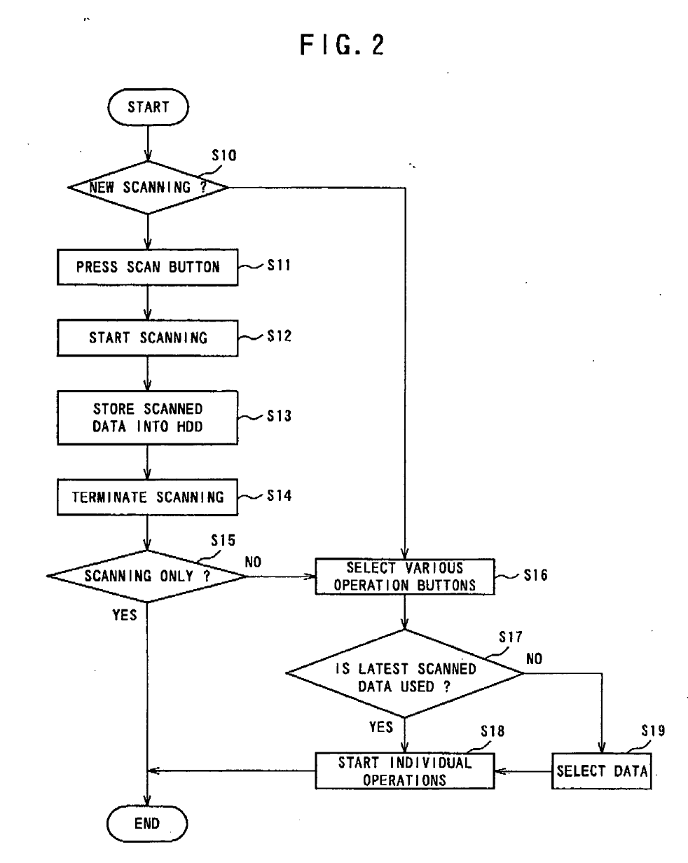

Hereinafter, a preferred embodiment of the present invention will be described in detail while referring to the accompanying drawings. FIG. 1 is a view that illustrates a constructional example of an image reading apparatus according to the present invention. FIG. 2 is a flow chart that illustrates the control operation of a CPU shown in FIG. 1. An image processing apparatus (image forming apparatus) 100 shown in FIG. 1 includes a CPU 10, a ROM 11, a RAM 12, an HDD 13 (or it can be replaced with another rewritable nonvolatile storage device), and an input and output part 14, an image processing part 15, a scanning part 16, a fax part 17, an email part 18, and a printing part 19. Here, note that the scanning part 16 constitutes a scanning function part of the present invention, and the fax part 17, the email part 18 and the printing part 19 together constitute a subsequent processing function part of the present invention.

The CPU 10 controls the respective parts by using control programs stored in the ROM 11, the function of the RAM 12 and so on. The input and output part (input part) 14 receives, from a user, an instruction (for example, an instruction from a button displayed on a display screen of the input and output part 14) necessary for the control of the CPU 10 and provide a necessary display. The image processing part 15 applies necessary image processing (compression, etc.) to image data read out by the scanning part 16, or performs necessary image processing (rotation, expansion, resolution conversion, format conversion, etc.) on image data read out from the HDD 13, and delivers the image data thus processed to the respective parts (printing part 19, etc.) that perform processes subsequent to the scanning. The fax part 17 carries out fax transmission via a telephone line or the like based on the received data. The email part 18 transmits (ifaxes and emails, etc.) the received data via a LAN or the like.

Next, reference will be made to the control operation of the CPU 10 shown in FIG. 1 while referring to FIG. 2. Upon activation of the image processing apparatus 100, the CPU 10 makes an inquiry through the input and output part 14 as to whether to perform a new scan or to perform subsequent processing of image data that has already been scanned and stored in the HDD 13 (S10), When a scan button arranged in the input and output part 14 is pressed so as to perform a new scan (S11), the CPU 1O starts reading a document that is set on the image processing apparatus 100 by driving the scanning part 16 (S12 (scan step)), performs necessary image processing on the image data (scanned data) thus read, stores the image data thus processed in the HDD 13 (S13 (image data storage step)), and once or temporally terminates the scan operation. After the termination of the scan operation, an inquiry as to whether processing operations subsequent to the scan operation are to be performed is made through the input and output part 14 (S15),

When an instruction to require no processing operation other than the scan operation is received in step S15, or when no instruction has been received within a predetermined time, the operation of the apparatus is ended after the termination of the scan operation alone (operation termination step). On the other hand, when an instruction to perform subsequent operations is received in step S15, an inquiry is made as to which one of the subsequent processes (e.g., print processing, fax transmission processing, etc.) is to be performed (S16), and when a button for selecting a prescribed subsequent process is pressed, an inquiry is made as to whether the latest ones among various pieces of scanned data to be processed by the prescribed subsequent process are to be used or pieces of scanned data other than the latest ones are to be used.

When the latest pieces of scanned data are used, they can be selected at once, so the CPU 10 selects the latest pieces of scanned data as they are, and starts the desired subsequent processing operation for the latest pieces of scanned data (S18 (subsequent processing step)). When the pieces of the scanned data other than the latest pieces of scanned data are to be processed, those pieces of scanned data which have the numbers corresponding to the pieces of scanned data to be processed are selected (S19), so the routine or control flow proceeds to step S18. When respective processing operations having been started in step S18 are terminated, the processing of the entire routine is completed. On the other hand, when the subsequent processing operations have been executed for the data not newly scanned but having previously been scanned and stored in step S10, the routine proceeds from step S10 to step S16.

As can be seen from the above-mentioned embodiment, in the image processing apparatus 100, for example, when an instruction to scan a multitude of sheets of a document is given, the CPU 10 for carrying out overall control makes the document read out by the scanning part 16, stores the scanned data thus read out in the HDD 13, and once or temporally terminates the operation in the case of the absence of an instruction to perform a subsequent operation. Thereafter, when an instruction to perform a subsequent processing such as for instance printing (copying) on the above-mentioned scanned data stored in the HDD 13 is received from the user through the input and output part 14, the corresponding scanned data is read out from the HDD 13, the printing part 19, which performs printing corresponding to the received instruction among a plurality of subsequent processing functions, is operated so that the task of copying the document for the read scanned data can be completed.

In the above-mentioned case, when a request for fax transmission of another urgent document for example is made in the absence of a print instruction after the operation of the scanning part 16 has been terminated, the fax document (i.e., document to be faxed) is read, the scanned data of the fax document thus read is stored in the HDD 13, and then the operation is once or temporally terminated. However, if an instruction for fax transmission is subsequently given, the fax transmission is carried out. Thereafter, when an instruction to print the scanned data of the previous copy document is received, the scanned data is printed and the copy operation for the multitude of sheets is completed. In this manner, in the image processing apparatus 100, a task comprising a scan operation and processing operations subsequent to the scan operation, which were series of operations in the past, can be divided into the scan operation and the subsequent processing operations, so that other operations can be executed as required between the scan operation and the subsequent processing operations. Accordingly, the processing order of the operations becomes flexible, and hence the scanned data can be converted or utilized later for other subsequent processing.

Although in the above-mentioned embodiment, reference has been made to the case where the functions to execute programs shown in the respective flow charts are beforehand recorded in the image processing apparatus, the present invention is not limited to this but similar functions can be downloaded into the apparatus via a network, or a computer-readable recording medium storing therein similar functions can be installed in the apparatus. In this regard, it is to be noted that the recording medium can be of any form, such as for example a ROM, which is able to store programs and which is able to be read out by the apparatus. In addition, the functions to be obtained by such preinstallation or downloading can be achieved through cooperation with an OS (operating system) or the like in the interior of the apparatus.

As described in the foregoing, according to the present invention, the acquisition of image data by scanning and subsequent processing operations can be separated from one another, so that it is possible to deal with other operations, if exist, which are wanted to be interrupted therebetween, thus making it possible to reduce a long time spent waiting for other image processing execution requests. In addition, the acquired same image data can also be respectively used for different subsequent processing, so image processing can be performed in a more flexible and efficient manner.

What is claimed is:

1. An image processing apparatus comprising:
a scan function part that acquires image data by reading a document;
an image data storage part that stores said image data acquired by said scan function part;
an input part by which an instruction for subsequent processing with respect to the processing performed by said scan function part; and
a subsequent processing function part that performs said subsequent processing based on said instruction for subsequent processing input by said input part by using said image data stored in said image data storage part.

2. The image processing apparatus as set forth in claim 1, wherein said subsequent processing function part has a function to perform a plurality of kinds of subsequent processing operations that can be selected by said input part.

3. The image processing apparatus as set forth in claim 1, wherein subsequent processing functions that can be executed by said subsequent processing function part include at least a print function and a fax transmission function.

4. An image processing apparatus comprising:
a scan function part that acquires image data by reading a document;
an image data storage part that can store said image data acquired by said scan function part;
a subsequent processing function part that can perform subsequent processing with respect to the scan processing of said scan function part;
an input part by which an instruction for the subsequent processing performed by said subsequent processing function part;
a control part that stores said image data read by said scan function part in said image data storage part, temporally terminates the processing operation, and actuates, upon receipt of said instruction for subsequent processing through said input part, said subsequent processing function part thereby to perform said subsequent processing on said image data stored in said image data storage part.

5. An image processing method comprising:
a scan step of acquiring image data by reading a document:
an image data storage step of storing said image data acquired in said scan step;
an input step of inputting an instruction for subsequent processing with respect to the processing performed in said scan step; and
a subsequent processing step of performing said subsequent processing based on said instruction for subsequent processing input in said input step by using said image data stored in said image data storage step.

6. An image processing method comprising:
a scan step of acquiring image data by scanning a document;
an image data storage step of storing said image data thus acquired;
an operation termination step of temporally terminating the processing operation until an instruction for subsequent processing on said stored Image data is given; and
a subsequent processing step of performing, upon receipt of an instruction for subsequent processing on said image data, subsequent processing corresponding to said instruction by using said image data stored in said image data storage step.

7. An image processing program adapted to be executed in a computer of an image processing apparatus, said program being operable to make said computer execute:
a scan step of acquiring image data by reading a document;
an image data storage step of storing said image data acquired in said scan step;
an input step of inputting an instruction for subsequent processing with respect to the processing performed in said scan step; and
a subsequent processing step of performing said subsequent processing based on said instruction for subsequent processing input in said input step by using said image data stored in said image data storage step.

8. An image processing program adapted to be executed in a computer of an image processing apparatus, said program being operable to make said computer execute;
a scan step of acquiring image data by scanning a document;
an image data storage step of storing said image data thus acquired;
an operation termination step of temporally terminating the processing operation until an instruction for subsequent processing on said stored image data is given; and
a subsequent processing step of performing, upon receipt of an instruction for subsequent processing on said image data, subsequent processing corresponding to said instruction by using said image data stored in said image data storage step.
